(19) United States
(12) Patent Application Publication
(10) Pub. No.: US 2008/0095187 A1
(43) Pub. Date: Apr. 24, 2008

(54) METHOD FOR ESTIMATING AVAILABLE BANDWIDTH OF NETWORK LINK USING TIME STAMP FUNCTION OF INTERNET CONTROL MESSAGE PROTOCOL

(76) Inventors: Tae In JUNG, Seoul (KR); Myeong-Seok Cha, Ahnyang-si (KR); Hyung-Jong Kim, Seoul (KR); Won Tae Sim, Sungnam-si (KR); Woo-Han Kim, Seoul (KR)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(21) Appl. No.: 11/553,253

(22) Filed: Oct. 26, 2006

(30) Foreign Application Priority Data
Oct. 20, 2006 (KR) 10-2006-0102378

(51) Int. Cl. H04J 3/22

(52) U.S. Cl. 370/468; 370/392

(57) ABSTRACT

Disclosed is a method for estimating an available bandwidth of a network link by transmitting small-sized probing packets using a time stamp function of an Internet control message protocol (ICMP) and using time information of the probing packet returned. According to the invention, even when the separate program or function is not activated in the router, it is possible to easily estimate and monitor the available bandwidth of the exterior network link connected to the network being managed. Accordingly, it is possible to operate the network more stably and to detect the abnormal sign of the network at early stage, thereby quickly coping with it. In addition, it is possible to prevent the excessive traffic or load from being caused in the network.

### CROSS-REFERENCE TO RELATED APPLICATIONS

This application claims all benefits of Korean Patent Application No. 10-2006-0102378 filed on Oct. 20, 2006 in the Korean Intellectual Property Office, the disclosures of which are incorporated herein by reference.

### BACKGROUND OF THE INVENTION

1. Field of the Invention

The present invention relates to a method for estimating an available bandwidth of a network link using a time stamp function of an Internet Control Message Protocol (ICMP).

2. Description of the Prior Art

As the Internet has been developed, capacity and size of a network have been remarkably increased. In addition, with respect to a router playing an important role in the data transmission, products of various types and performances have been equipped and operated. With the development of the network infrastructure, the technologies for stably operating it have been also developed.

In order to stably operate network, it is important to measure an available bandwidth between links, to continuously monitor it and to maintain a proper available bandwidth. The available bandwidth is highly affected by circuit trouble due to a physical accident, network congestion due to a traffic upsurge, DDoS (Distribute Denial of Service) attack and the like.

Accordingly, it is possible to detect an abnormal sign of the network by measuring the available bandwidth. The recent virus and worm scan a vulnerable target for self-propagation and generate excessive traffic for the scanning. Therefore, when the excessive traffic is detected at the early stage, it is possible to stably operate the network and to prevent the propagation of virus and worm at the early stage. In addition, in case of the DoS (Denial of Service) attack using a malicious Bot, it causes the excessive traffic in the network to which an attack-target belongs and another network corresponding to the intermediate point. Accordingly, a manager to manage the network can detect the DoS attack by monitoring main links of other networks interlocked with the network that the manager operates.

In order to continuously monitor the available bandwidth, it is necessary to add the function of monitoring the available bandwidth to the router that is a core equipment of the network and to activate the function. In addition, in order to calculate the available bandwidth of the network, it is required to additionally equip and operate a program having such function to the target network node or to operate the function that has been already retained.

However, when a manager installs a new program so as to monitor the main links of the network interlocked with the network that the manager operates, much time and costs are required. In addition, in case of activating the function of monitoring the network bandwidth in the router, a significant load is caused in the router. In addition, since a security problem may be caused, the information about the available bandwidth is not generally opened to the outside. Accordingly, even when the function of monitoring the network bandwidth is activated in the router, it is impossible to obtain the information about the available bandwidth of another network.

As a technology for calculating the available bandwidth in a remote node, it is known a ping technology of sending an ICMP echo packet and measuring a round trip time thereof to calculate a delay time between specific links of the network. However, according to this technology, when a forward route through which the packet is transmitted to the target node is different from a return route, the accuracy is decreased.

### SUMMARY OF THE INVENTION

Accordingly, the present invention has been made to solve the above problems. In the invention, a probing packet is transmitted using a time stamp function of an Internet Control Message Protocol (ICMP), and an available bandwidth of a network link is estimated using time information of the probing packet returned.

According to the invention, it is possible to easily estimate and monitor an available bandwidth of an exterior network link connected to a network being operated, even when a separate program or function is not activated in a router. Accordingly, it is possible to operate the network more stably and to detect an abnormal sign in the network, thereby quickly coping with it. In addition, it is possible to prevent excessive traffic or load from being caused in the network.

Accordingly, an object of the invention is to provide a method for estimating an available bandwidth of a network link using a time stamp function of the ICMP.

In order to achieve the above object, there is provided a method for estimating an available bandwidth of a network link using a time stamp function of an ICMP. The method of the invention comprises steps of: (a) transmitting a first packet (packet 1) to a node b which is a back node of a network link for which it is intended to estimate an available bandwidth; (b) transmitting a second packet (packet 2) and a third packet (packet 3) to a node a which is a front node of the network link; and (c) calculating an available bandwidth of the network link from time information of time stamps recorded in the packets 1 to 3 transmitted.

### BRIEF DESCRIPTION OF THE DRAWINGS

The above and other objects, features and advantages of the present invention will be more apparent from the following detailed description taken in conjunction with the accompanying drawings, in which:

FIG. 1 is a conceptual view for illustrating a network structure to which it is applied a method for estimating an available bandwidth of a network according to an embodiment of the invention;

FIG. 2 is a view for illustrating k probing packets which are used for a method for estimating an available bandwidth of a network according to an embodiment of the invention, and the number (N(k)) of packets having a zero queue delay;

FIG. 3 is a view for illustrating a method for estimating an available bandwidth of a link using three (3) packets, according to an embodiment of the invention;

FIG. 4 is a view for illustrating a method for estimating an available bandwidth between multiple nodes, according to an embodiment of the invention; and

FIG. 5 is a flow chart showing a process for estimating an available bandwidth of a network link according to an embodiment of the invention.

### DETAILED DESCRIPTION OF THE PREFERRED EMBODIMENTS

Hereinafter, a preferred embodiment of the present invention will be described with reference to the accompanying drawings. In the following description of the present invention, a detailed description of known functions and configurations incorporated herein will be omitted when it may make the subject matter of the present invention rather unclear.

In the present invention, an available bandwidth is meant by a current available bandwidth of an overall bandwidth in a specific link of a network. The available bandwidth can be expressed by a ratio to the overall bandwidth of a node (available bandwidth ratio). In general, a router which is a network equipment can know an overall bandwidth of a link to which the router belongs and statistics of traffics which the router processes. Accordingly, it is possible to easily calculate an available bandwidth using the two informations. A following equation 1 shows a relation of an available bandwidth, a load and a bandwidth.

a=c(1−ρ) [equation 1]

where,
a: available bandwidth [bit/sec]
c: bandwidth of a node [bit/sec]
ρ: load of a node.

According to the equation 1, the available bandwidth has a value ranging from 0 to the bandwidth c, depending on the load applied to the node.

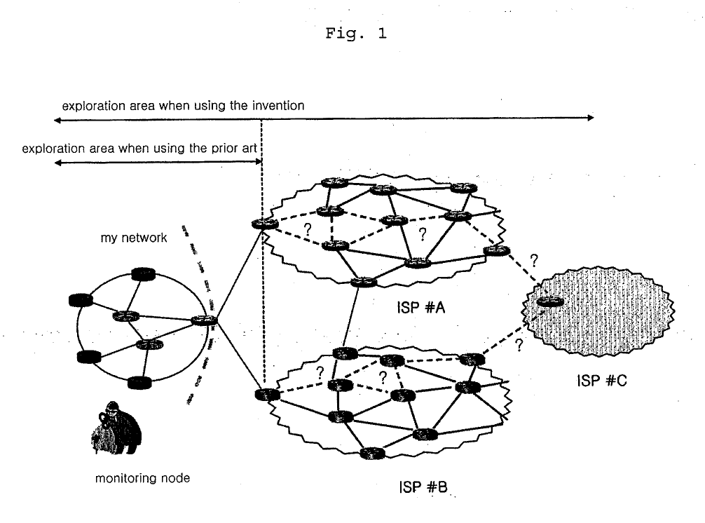

FIG. 1 is a conceptual view for illustrating a network structure to which it is applied a method for estimating an available bandwidth of a network according to an embodiment of the invention.

In case of using a function of monitoring an available bandwidth of a conventional router, the router can monitor only a link in the network to which the router belongs. Accordingly, it is impossible to estimate an available bandwidth of a specific link (which is indicated as ‘?’ in FIG. 1) of other network (ISP (Internet Service Provider) #A, #B and #C) interlocked with the network that the router is connected to.

However, according to the invention, the available bandwidth information of a router is not used, and instead, time stamp information of an ICMP is instead used at a remote location. In other words, according to the invention, when an ICMP probing packet is transmitted and the routers at both ends of a link for which it is intended to know an available bandwidth respond to the packet, the available bandwidth is estimated using the time stamp information in the packet. Accordingly, even though the link belongs to other network not directly managed, when the routers at both ends of the link support the time stamp function to respond to the ICMP packet, it is possible to estimate the available bandwidth.

The ICMP time stamp function is a function capable of receiving and processing a packet at a specific node and recording time information in a header of the packet when transferring the received packet to a next node.

A following equation 2 shows how to obtain an available bandwidth from the time stamp information of the ICMP (herein, it is assumed that a router is an output-queued switch model whose output is processed through a queue).

$${lim}_{k -> ∞} \frac{N ( k )}{k} = 1 - ρ \qquad [ equation 2 ]$$

where,
k: number of packets
N(k): number of packets having a zero queue delay, among the k probing packets.

In other words, when the k probing packets are sent and the number (N(k)) of packets having a zero queue delay is then measured, an available bandwidth can be calculated with the equation 2.

FIG. 2 is a view for illustrating k probing packets and the number (N(k)) of packets having a zero queue delay. It is assumed that nodes at both ends of a target link for which it is intended to calculate an available bandwidth are respectively a and b. When the number of packets having no queue delay is known in the node a, it is possible to estimate the load ρ of the node a using the equation 2. Through the estimation of load ρ, it is possible to calculate an available bandwidth of the link from the node a to the node b.

Herein, when it is desired to obtain an accurate time stamp value of the packet so as to check whether the packet is delayed, it is necessary for a cross traffic not to intervene between the probing packets. In the present invention, 3 (three) probing packets are used so that the cross traffic does not occur.

First, in order to estimate the available bandwidth according to the invention, following two conditions should be satisfied.

(i) the routers at both ends of a target link should respond to the ICMP time stamp packet; and

(ii) routes to the target link should be same while transmitting the three probing packets.

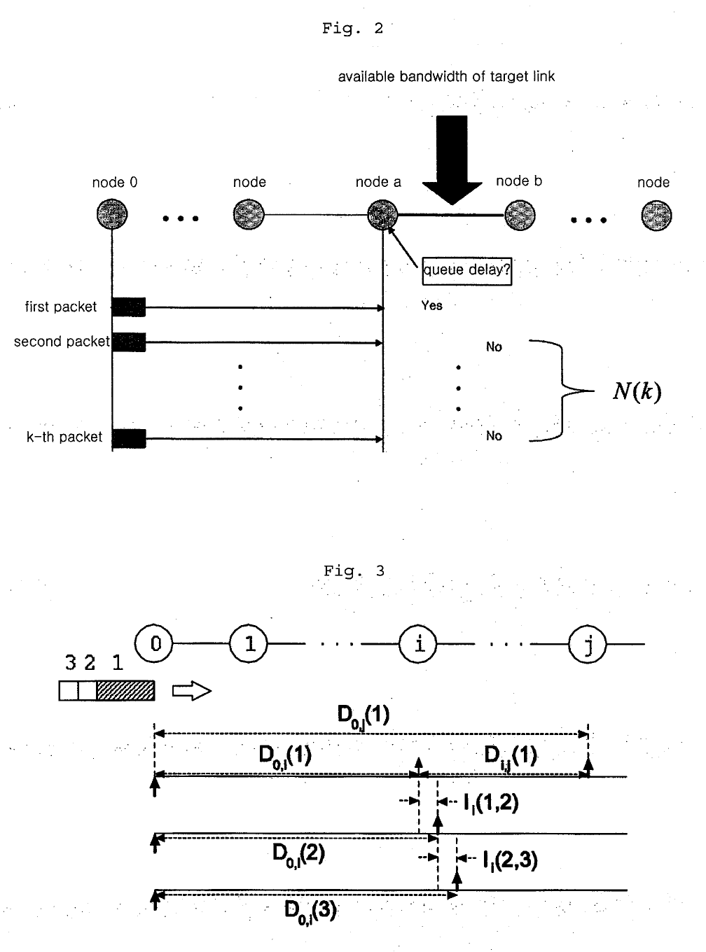

FIG. 3 is a view for illustrating a method for estimating an available bandwidth of a link using 3 (three) packets.

It is assumed that nodes at both ends of a target link for which it is intended to calculate an available bandwidth are i and j. In the present invention, an exploration node transmits three ICMP packets. The first packet is transmitted to the node j, the second and third packets are transmitted to the node i. Herein, if the other packets intervene between the three packets, the estimation accuracy of the available bandwidth is lowered. Accordingly, in the present invention, a following proposition 1 is used so that the cross traffic cannot intervene between the 3 (three) packets during an exploration period.

[Proposition 1]

A packet k is transmitted at a node n+1 and packets k+1 and k+2 are transmitted at a node n. The three packets are transmitted back-to-back at a node 0. At this time, if a following equation 3 is satisfied, the cross traffic does not occur between the packets k and k+1 and between the packets k+1 and k+2 to the node j (≦n).

$$\frac{{L}_{k}}{{L}_{k + 1}} ≻ {max}_{m \leq j - 1} \frac{2 {C}_{m}}{{C}_{m - 1}} \qquad [ equation 3 ]$$

where,
Lₖ: size of the packet k [byte],
max(.): maximum of a function (.), and
Cₘ: bandwidth of a node m [byte/sec].

When the inequality in the equation 3 is satisfied, a following equation 4 is satisfied.

$${D}_{0 , i} ( k + 1 ) - {D}_{0 , i} ( k ) = {D}_{0 , i} ( k + 2 ) - {D}_{0 , i} ( k + 1 ) = \frac{{L}_{k + 1}}{{C}_{i - 1}} \qquad [ equation 4 ]$$

where,
D_{0,i}(k): delay of the packet k during the transmission from the node 0 to the node i [sec].

In other words, when the size ratio of the packets k and k+1 is greater than two times of a bandwidth ratio of nodes m and m−1 (i.e., the equation 3 is satisfied), there is no cross traffic (the equation 4 is satisfied). For example, in a situation that a bandwidth of the node m is 100 Mbps and a bandwidth of the node m−1 is 10 Mbps, if a size of the packet k is set to be 1500 bytes and a size of the packet k+1 is set to be 40 bytes, the equation 3 becomes a following equation 5.

$$\frac{1500}{40} ≻ \frac{2 \times 100}{10} \qquad [ equation 5 ]$$

Accordingly, in case of transmitting the three packets back-to-back, when a size of the first packet is set to be very great (1500 bytes which is a maximum packet size typically allowable) and sizes of the second and third packets are set to be very small (40 bytes which is a minimum packet size typically allowable), thereby satisfying the equation 3, the cross traffic does not intervene between the test packets. When the packet sizes are set as such, the left side of the equation 3 is 37.5. Accordingly, if the bandwidth ratio Cₘ/Cₘ₋₁ of the right side is less than 18.75, the inequality of the equation 3 is satisfied.

In other words, even when it is impossible to know a specified bandwidth value of a node in the equation 3, if a node for which: it is intended to estimate an available bandwidth has a bandwidth of 18 times or less as compared to a node just before it, when a size of the first packet is set to be 1500 bytes and sizes of the second and third packets are set to be 40 bytes, the cross traffic does not intervene between the test packets, as described above. Since the net-work is hierarchically structured so as to prevent a bottleneck phenomenon, the above assumption is generally appropriate.

Likewise, since the bandwidth values between the network links are not different highly, if a size of the first packet is set to be about 8 times or more as large as those of the second and third packets (preferably, about 20 times or more), the relation of the packet sizes satisfies the equation 3, so that the cross traffic does not intervene between the test packets.

In order to obtain a result value more accurate, it is preferred to repeatedly transmit the probing packets several times and to probabilistically express an available bandwidth using the result value.

A following equation 6 shows Iᵢ(1, 2) representing a difference between delays of the packets 2 and 1 to the node i and Iᵢ(2, 3) representing a difference between delays of the packets 3 and 2 to the node i.

Iᵢ(1,2)=D_{0,i}(2)−D_{0,i}(1)

Iᵢ(2,3)=D_{0,i}(3)−D_{0,i}(2) [equation 6]

In addition, in the present invention, it is assumed that there is no cross traffic among the three packets k, k+1 and k+2 and corresponding queues are not vacant from arrival time of the packet k until arrival time of the packet k+2. In this case, a following equation 7 is satisfied.

D_{0,i}(k+1)−D_{0,i}(k)≈D_{0,i}(k+2)−D_{0,i}(k+1) [equation 7]

In addition, a following equation 8 is also satisfied.

D_{0,i+1}(k+1)−D_{0,i+1}(k)≈D_{0,i+1}(k+2)−D_{0,i+1}(k+1) [equation 8]

In other words, it can be seen that the delay difference of the (k+1)^{th} and k^{th} packets in the node i is approximately same as that of the (k+2)^{th} and (k+1)^{th} packets. In addition, this is also true in the node i+1.

In the mean time, D_{0,i}(1)=D_{0,i}(2)−Iᵢ(1,2) can be expressed as D_{0,i}(1)=D_{0,i}(2)−Iᵢ(2,3) by the equations 6 to 8. In addition, if it is assumed that \hat{D}_{0,i}(1)≈D_{0,i}(1), an estimated delay time of the packet 1 from the node 0 to the node i can be induced as follows.

\hat{D}_{0,i}(1)=D_{0,i}(2)−Iᵢ(2,3) [equation 9]

where,
\hat{D}_{0,i}(k): estimated delay value of the packet k when the packet k is transmitted from the node 0 to the node i [msec].

In addition, using the equation 9, the estimated delay from the node i to the node j can be induced as a following equation 10.

$$\begin{matrix}{\hat{D}}_{i , j} ( 1 ) = {D}_{0 , j} ( 1 ) - {\hat{D}}_{0 , i} ( 1 ) \\ = {D}_{0 , j} ( 1 ) - \{ {D}_{0 , i} ( 2 ) - {I}_{i} ( 2 , 3 ) \} \\ = {D}_{0 , j} ( 1 ) - \{ {D}_{0 , i} ( 1 ) + {I}_{i} ( 1 , 2 ) - {I}_{i} ( 2 , 3 ) \} \\ = {D}_{i , j} ( 1 ) - \{ {I}_{i} ( 1 , 2 ) - {I}_{i} ( 2 , 3 ) \}\end{matrix} \qquad [ equation 10 ]$$

In the equation, \hat{D}_{i,j}(1) is appropriate as an estimated value of D_{i,j}(1), but has a difference by an error item vᵢ. The error item vᵢ is defined as vᵢ=Iᵢ(1,2)−Iᵢ(2,3) and fvᵢ is defined as a probability density function of vᵢ. The probability density function can be obtained from data which is acquired by repeatedly transmitting the test probing packets several times.

It is assumed that Iᵢ(1,2) and Iᵢ(2,3) are independent of each other and are respectively finite with a range of an interval [δ1, δ2](δ1<δ2). Then, it can be seen that fvᵢ(x) is symmetrical to x=0, as a following equation 11.

fvᵢ(x)=fvᵢ(−x),−(δ₂−δ₁)<x<(δ₂−δ₁) [equation 11]

In addition, when |x|>(δ₂−δ₁), fvᵢ(x)=0.

It is defined that δ=δ₂−δ₁ and that D^{m}_{i,j}=min{D_{i,j}(1)}. If it is assumed that D_{i,j}(1) is independent of vᵢ, the distribution of \hat{D}_{i,j}(1) is expressed by a following equation 12 for γ≧δ.

$$\begin{matrix} [ equation 12 ] \\ \begin{matrix}Pr ( {\hat{D}}_{i , j} ( 1 ) \leq {D}_{i , j}^{m} + γ ) = Pr ( {D}_{i , j} - {v}_{i} \leq {D}_{i , j}^{m} + γ ) \\ = {\int }_{- ∞}^{∞} Pr ( {D}_{i , j} ( 1 ) - x \leq {D}_{i , j}^{m} + γ \vert {v}_{i} = x ) {fv}_{i} ( x ) d x \\ = {\int }_{- ∞}^{∞} Pr ( {D}_{i , j} ( 1 ) \leq {D}_{i , j}^{m} + γ + x ) {fv}_{i} ( x ) d x\end{matrix}\end{matrix}$$

It is assumed that the dimension of δ is very small as compared to D_{i,j}(1), a cumulative probability distribution of D_{i,j} exhibits a linear characteristic as shown in an equation 13 for [D^{m}_{i,j},D^{m}_{i,j}+3δ].

Pr(D_{i,j}(1)≦D^{m}_{i,j}+x)≈αx+β, 0≦x≦3δ [equation 13]

Through the equations 12 and 13, a following equation 14 is obtained for γ(δ≦γ≦2δ).

Pr(\hat{D}_{i,j}(1)≦D^{m}_{i,j}+γ)≅∫_{δ}^{δ{α(}x+γ)+β}fvᵢ(x)dx=αγ+β [equation 14]

Through the equation 13, a probability that the probing packet arrived will reach a vacant queue system (node) in a zero delay probability of Pr(D_{i,j}(1)≦D^{m}_{i,j}) is expressed as an equation 15.

Pr(D_{i,j}(1)≦D^{m}_{i,j})≅β [equation 15].

Considering the cases of γ=δ and γ=2δ, a following equation 16 is obtained.

Pr(\hat{D}_{i,j}(1)≦D^{m}_{i,j}+δ)≅αδ+δ

Pr(\hat{D}_{i,j}(1)≦D^{m}_{i,j}+2δ)≅2αδ+β [equation 16]

If the equations 15 and: 16 are combined, a following equation 17 is obtained.

Pr(D_{i,j}(1)≦D^{m}_{i,j})≅2Pr(\hat{D}_{i,j}(1)≦D^{m}_{i,j}+δ)−Pr(\hat{D}_{i,j}(1)≦D^{m}_{i,j}+2δ) [equation 17]

Accordingly, from the equation 17, it can be seen that a probability (Pr(D_{i,j}(1)≦D^{m}_{i,j}) that the delay (D_{i,j}(1)) of the packet 1 between the nodes i and j will be smaller than the minimum delay (D^{m}_{i,j}) can be approximated even using the estimated delay (\hat{D}_{i,j}(1)) of the packet 1 between the nodes i and j.

Herein, Pr(D_{i,j}(1)≦D^{m}_{i,j}) means a probability that a first packet in the node i will have not a queue delay. That is, if the value thereof is 1, a probability that the first packet will have not a queue delay in the node i is 100%. This means that load of the node i is 0. Meanwhile, if the value thereof is 0.3, a probability that the first packet will have not a queue delay in the node i is 30%. This means that load of the node i is 0.7. In other words, if there is a queue delay, this means that a bandwidth is used because there is load in the corresponding node. If there is no queue delay, this means that there is no load in the corresponding node.

In the mean time, if n≧n*_{i,j}(n*_{i,j}=[D^{m}_{i,j}/Ω] an inequality of a following equation 18 is satisfied.

Pr(\hat{D}′_{i,j}(1)≦nΩ)≦Pr(D_{i,j}(1)−X<(n+1)Ω),

Pr(\hat{D}′_{i,j}(1)≦nΩ)≧Pr(D_{i,j}(1)−X<nΩ) [equation 18]

where,
Ω is the smallest time unit (for example, 1 msec) provided from the ICMP time stamp.

In other words, the distribution of \hat{D}′_{i,j}(1) has the upper and lowest limits determined by the probability distribution of \tilde{D}_{i,j}(1)=D_{i,j}(1)−X.

In the mean time, the probability of \tilde{D}_{i,j}(1) can be expressed by a following equation 19.

$$\begin{matrix}Pr ( \begin{matrix}{\tilde{D}}_{i , j} ( 1 ) \leq \\ {D}_{i , j}^{m} + n Ω\end{matrix} ) = Pr ( {D}_{i , j} ( 1 ) \leq {D}_{i , j}^{m} + n Ω ) \\ = {\sum }_{k = - 1}^{1} Pr ( {D}_{i , j} ( 1 ) - X \leq {D}_{i , j}^{m} + n Ω \vert X = k Ω ) \\ Pr ( X = k Ω ) \\ = {\sum }_{k = - 1}^{1} Pr ( {D}_{i , j} ( 1 ) \leq {D}_{i , j}^{m} + ( n + k ) Ω ) \\ Pr ( X = k Ω )\end{matrix} \qquad [ equation 19 ]$$

At this time, on the assumption that Pr(X=−Ω)=Pr(X=Ω)=α_{Ω} and D_{i,j}(1) is linear for n≧1, it is satisfied:

Pr(D_{i,j}(1)≦D^{m}_{i,j}+(n−1)Ω)+Pr(D_{i,j}(1)≦D^{m}_{i,j}+(n+1)Ω)=2Pr(D_{i,j}(1)≦D^{m}_{i,j}+nΩ)

Since the size of δ is very small as compared to D_{i,j}(1) and the cumulative probability distribution of D_{i,j} exhibits a linear characteristic as Pr(D_{i,j}(1)≦D^{m}_{i,j}+x)≅αx+β, 0≦x≦3δ of the equation 13 for [D^{m}_{i,j}, D^{m}_{i,j}+3δ], a following relation is obtained:

$$Pr ( {D}_{i , j} ( 1 ) \leq {D}_{i , j}^{m} + ( n + 1 ) Ω ) - Pr ( {D}_{i , j} ( 1 ) \leq {D}_{i , j}^{m} + n Ω ) = Pr ( {D}_{i , j} ( 1 ) \leq {D}_{i , j}^{m} + n Ω ) - Pr ( {D}_{i , j} ( 1 ) \leq {D}_{i , j}^{m} + ( n - 1 ) Ω )$$

In other words, in case of a linear function, an increment of y is constant as Ω of x increases.

From the above equations, a following equation 20 is obtained.

Pr(\tilde{D}_{i,j}(1)≦D^{m}_{i,j}+nΩ)=Pr(D_{i,j}(1)≦D^{m}_{i,j}+nΩ), n=1, 2 [equation 20]

In addition, by the above equations, the following relations are obtained:

Pr(D_{i,j}(1)≦D^{m}_{i,j})≅β,Pr(D_{i,j}(1)≦D^{m}_{i,j}Ω)≅αΩ+β,Pr(D_{i,j}(1)≦D^{m}_{i,j}+2Ω)≅2αΩ+β.

Accordingly, Pr(D_{i,j}(1)≦D^{m}_{i,j}) is defined as a following equation 21.

Pr(D_{i,j}(1)≦D^{m}_{i,j}) 2Pr(\tilde{D}_{i,j}(1)≦D^{m}_{i,j}+Ω)−Pr(\tilde{D}_{i,j}(1)≦D^{m}_{i,j}+2Ω) [equation 21]

Finally, it is possible to estimate an available bandwidth ratio using the equation 21. A detailed estimation process will be described later.

Even when a link for which it is intended to know an available bandwidth is a multiple node rather than a single node, it is possible to estimate an overall available bandwidth of the link in the similar manner.

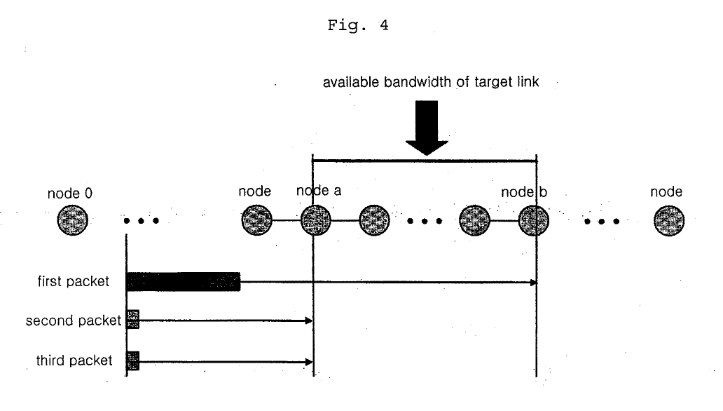

FIG. 4 is a view for illustrating a method for estimating an available bandwidth between multiple nodes. In FIG. 4, when nodes at both ends responding to the ICMP packet, in the target link for which it is intended to know the available bandwidth, the nodes at both ends are defined as nodes a and b. Then, it is possible to estimate an overall available bandwidth from the node a to the node b using the same manner as in the case of the single node. A following equation 22 represents an overall available bandwidth between the nodes a and b in FIG. 4.

$${lim}_{k -> ∞} \frac{N ( k )}{k} = ( 1 - {ρ}_{a} ) ( 1 - {ρ}_{a + 1} ) ⋯ ( 1 - {ρ}_{b - 1} ) \qquad [ equation 22 ]$$

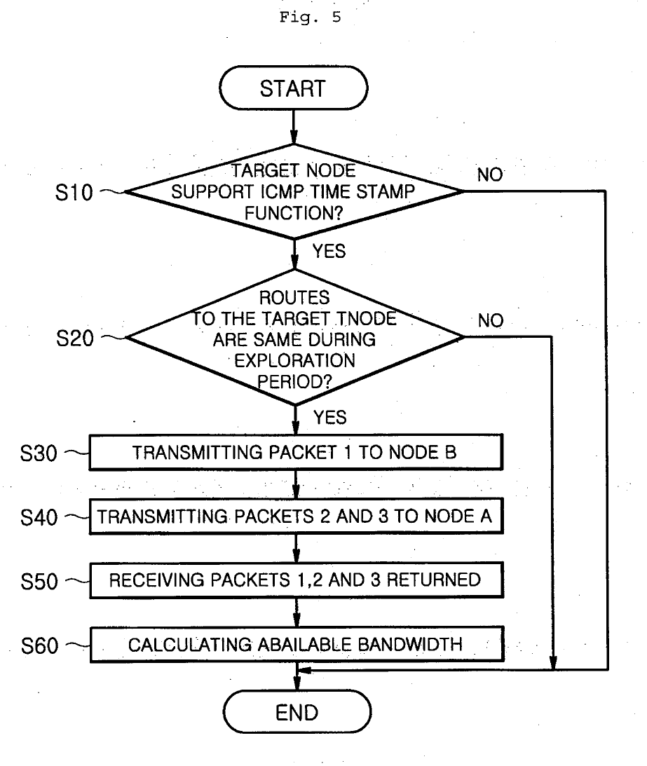

FIG. 5 is a flow chart showing a process for estimating an available bandwidth of a network link according to an embodiment of the invention.

In the present invention, it is checked whether nodes (a and b) at both ends of a link to be measured respond to the ICMP packet and provide a time stamp function (S10). In the step S10, in order to check whether a target node supports a time stamp function, a packet is transmitted to the target node with an option for recording the time stamp information when using a command of ping being set. When there is the time stamp information in a response packet from the target node, it is confirmed that the node provides the time stamp function.

Then, it is checked whether routes to the node a are constant (S20). In the step S20, in order to check whether the routes to the front node are same during the exploration period, a command of tracert is used for the target node several times and compared. Most of ISPs use a routing protocol referred to as BGP so as to set a route in the ISP and to set a route between the different ISPs. Since it is policy-based routing protocol, the constant route is mostly maintained. In addition, even though the route is changed, the changed route is reflected after a predetermined time period has lapsed. Accordingly, in case of transmitting the three packets back-to-back in a short time, as in the present invention, it can be assumed that the routes to the front node of the target node are same.

The two conditions (i.e., node provides the time stamp function and the routes to the node a are constant) are conditions for applying the invention.

Then, one packet (packet 1) is transmitted to a node b which is a back node of the link (S30), and two packets (packet 2, packet 3) are transmitted to a node a which is a front node of the link (S40). The three packets should be transmitted back-to-back.

When the three packets are returned (S50), the time stamp information of the packets is used to calculate an available bandwidth (S60).

In the followings, it will be described a process of estimating an available bandwidth using the time information recorded by the time stamps of the packets. In the present invention, the time information of the packet received is used to calculate an estimated delay value and a minimum delay value. This is repeated several times to make a cumulative probability distribution and the estimated delay value and the minimum delay value are finally compared to determine whether the probing packet is delayed, thereby estimating a range of the available bandwidth.

The smallest unit provided from the ICMP time stamp in a real network environment is referred to as Ω. A value of Ω in the current network environment is typically 1 msec. The time stamp-based delay of a packet p from a node 0 to a node i is defined as D_{0,i}(p)=α^{p}ᵢ−α^{p}₀. Herein, α^{p}ᵢ is an arrival time of the packet p at the node i and α^{p}₀ is an arrival time of the packet p at the node 0. In this case, it is impossible to know a correct value of D′_{0,i}(p) due to a limited resolution of the current ICMP time stamp. Instead, it is possible to obtain D′_{0,i}(p)=Ω[α^{p}ᵢ/Ω]−Ω[α^{p}₀/Ω] using a minimum unit of the time stamp. Herein, D′_{0,i}(p) is a delay value obtained bu using the minimum unit of the time stamp. In addition, with regard to Iᵢ(1,2) and Iᵢ(2,3) of the equation 6, it is possible to obtain I′ᵢ(1,2) and I′ᵢ(2,3) reflecting the minimum unit of the time stamp by using the D′_{0,i}(p).

A difference (X) between I′ᵢ(1,2) and I′ᵢ(2,3) is defined as X=I′ᵢ(2,3)−I′ᵢ(1,2). At this time, a probability (Pr(X=Ω)) that X will be Ωis calculated as an equation 23.

$$\begin{matrix}Pr ( X = Ω ) = ( the number of packets of which the \\ delay of packet 3 and the delay of packet \\ 2 are different ) / ( the total number of packets \\ sent ) \times ( the number of packets of which the \\ delay of packet 3 and the delay of \\ packet 2 are same ) / ( the total number of \\ packets sent ) \\ = {a}_{Ω} where , Ω \text{:} the minimum unit of \\ delay provided from the time stamp .\end{matrix} \qquad [ equation 23 ]$$

In the mean time, a probability (Pr(X=0)) that X will: be 0 (i.e., a probability that there is no delay difference) is expressed by a following equation 24.

Pr(X=0)=1−2Pr(X=Ω)=α₀ [equation 24]

The minimum delay value (\hat{D}*_{i,j}) is expressed by a following equation 25.

\hat{D}*_{i,j}=Ω×min{n:Pr(\hat{D}′_{i,j}(1)≦nΩ)<α_{Ω}} [equation 25]

where,
α_{Ω}=Pr(X=Ω) and
\hat{D}′_{i,j}(1): delay value measured from the time stamp recorded in each packet.

Accordingly, a minimum n value satisfying the inequality of the equation 25 is obtained by using α_{Ω} calculated in the equation 23 and the measured delay value \hat{D}′_{i,j}(1), thereby estimating the minimum delay value (\hat{D}*_{i,j}). In fact, the estimated minimum delay value (\hat{D}*_{i,j}) is the upper limit of the minimum delay value (D*_{i,j}) but may be used as the minimum delay value.

The minimum delay value estimated in the equation 25 is used to estimate an available bandwidth. The available bandwidth can be expressed as the available bandwidth ratio as a following equation 1a. In the present invention, the available bandwidth ratio is estimated and then the bandwidth of the node is multiplied, thereby obtaining the available bandwidth.

$$( 1 - ρ ) = \frac{a}{c} \qquad [ equation 1 a ]$$

where,
a: available bandwidth [bit/sec]
c: bandwidth of a node [bit/sec]
ρ: load of a node
a/c=1−ρ: available bandwidth ratio of a node.

The bandwidth ratio (1−ρ) is Pr(D_{i,j}(1)≦D^{m}_{i,j}) and same as an equation 21.

Pr(D_{i,j}(1)≦D^{m}_{i,j})=2Pr(\tilde{D}_{i,j}(1)≦D^{m}_{i,j}+Ω)−Pr(\tilde{D}_{i,j}(1)≦D^{m}_{i,j}+2Ω) [equation 21]

In the equation 21, Ω is the minimum time unit of delay provided from the ICMP time stamp (in a real calculation of the embodiment, 1 msec is used which is suitable for a typical network environment).

When estimating a real available bandwidth, several observation intervals are provided and the available bandwidth is estimated repeatedly, rather than carrying out the observation only one time.

The right term of the equation 21 is calculated by using D*_{i,j} obtained through the equation 25 and calculating the other variables as follows.

First, D′_{0,j}(1), D′_{0,i}(2) and D′_{0,i}(3) are obtained from the time stamps of the three probing packets. Then, using these values, the delay (\hat{D}_{i,j}(1)) of the packet 1 between the nodes i and j is calculated with a following equation 26.

\hat{D}′_{i,j}(1)=D′_{0,j}(1)+D′_{0,j}(3)−2D′_{i,j}(2) [equation 26]

If D*_{i,j} is defined as the minimum delay between the nodes i and j, which can be obtained by a measurement, p₀, p_{Ω} and p_{2Ω} are defined as a following equation 27 and values thereof can be expected through the measurement.

p₀=Pr(\hat{D}′_{i,j}(1)≦D*_{i,j})

p_{Ω}=Pr(\hat{D}′_{i,j}(1)≦D*_{i,j}+Ω)

p_{2Ω}=Pr(\hat{D}′_{i,j}(1)≦D*_{i,j}+2Ω) [equation 27]

In addition, the values of p₀, p_{Ω} and p_{2Ω} observed in n^{th} (n=1, 2, 3, . . . ) observation interval are defined as p₀(n), p_{Ω}(n) and p_{2Ω}(n). The right term of the equation 21 in the n^{th} (n=1, 2, 3, . . . ) observation interval is calculated by using a following equation 28.

Pr(\tilde{D}′_{i,j}(1)≦D^{m}_{i,j}+Ω)≈(1−ξ(n))p₀(n)+ξ(n)p_{Ω}(n)

Pr(\tilde{D}′_{i,j}(1)≦D^{m}_{i,j}+2Ω)≈(1−ξ(n))p₀(n)+ξ(n)p_{2Ω}(n) [equation 28]

where,
ξ(n) is a parameter representing a phase of the minimum delay. In case of n=1, ξ(1) is estimated as \hat{ξ}(1) of a following equation 29.

$${ξ}^{⋒} ( 1 ) = \frac{{x}^{′}}{Ω} \qquad [ equation 29 ]$$

where,
x′ is expressed by a following equation 30.

$${x}^{′} = - \frac{1}{{C}_{3}^{′}} log \frac{{C}_{1}^{′} - {a}_{Ω} {p}_{2 Ω}}{{C}_{2}^{′}} \qquad [ equation 30 ]$$

In addition, C₁′, C₂′ and C₃′ are expressed by a following equation 31.

$${C}_{1}^{′} = {p}_{0} + \frac{{( {p}_{0} - {p}_{Ω} )}^{2}}{( 2 {p}_{Ω} - {p}_{0} - {p}_{2 Ω} )} \\ {C}_{2}^{′} = \frac{{( {p}_{0} - {p}_{Ω} )}^{3}}{( {p}_{0} - {p}_{2 Ω} )} \cdot \frac{1}{( 2 {p}_{Ω} - {p}_{0} - {p}_{2 Ω} )} \\ {C}_{3}^{′} = log ( \frac{( {p}_{0} - {p}_{Ω} )}{( {p}_{Ω} - {p}_{2 Ω} )} \cdot \frac{1}{Ω} ) \qquad [ equation 31 ]$$

In the mean time, when n>1, the value of ξ(n) is estimated with a following equation 32.

$${ξ}^{⋒} ( n ) = \frac{{G}_{n - 1} ( Ω ) - {p}_{0} ( n )}{{G}_{n - 1} ( Ω ) - {{a}_{Ω} ( n )}_{2 Ω} ( n - 1 )} \qquad [ equation 32 ]$$

where,
α_{Ω}(n): value of α_{Ω} obtained in the n^{th} observation interval,
Gₘ(x): defined, as a following equation 33 for an m^{th} exploration period,
Gₘ(Ω): value of Gₘ(x) when x=Ω, and
x″: delay value at an intersection point of two functions, f₁^{m}(x) and f₂^{m}(x)

$${G}_{m} ( x ) = \{ \begin{matrix}{f}_{1}^{m} ( x ) , if x ≺ {x}^{″} \\ {f}_{2}^{m} ( x ) , if x \geq {x}^{″}\end{matrix} \qquad [ equation 33 ]$$

where,
f₁^{m} (x), f₂^{m} (x) are respectively as a following equation 34.

f₁^{m}(x)=s₁^{m}(x−(1−ξ)Ω)+p₀(m)

f₂^{m}(x)=s₂^{m}(x−(2−ξ)Ω)+p_{Ω}(m) [equation 34]

In addition, s₁^{m}, s₂^{m} are respectively as a following equation 35.

$$\begin{matrix}{s}_{1}^{m} = \{ \begin{matrix}\frac{{p}_{0} ( m ) - {a}_{Ω} ( m ) {p}_{2 Ω} ( m )}{( 1 - ξ ) Ω} , & \begin{matrix}if \frac{{p}_{0} ( m ) - {a}_{Ω} ( m ) {p}_{2 Ω} ( m )}{( 1 - ξ ) Ω} > \\ \frac{{p}_{Ω} ( m ) - {p}_{0} ( m )}{Ω}\end{matrix} \\ \frac{{p}_{Ω} ( m ) - {p}_{0} ( m )}{Ω} , & otherwise\end{matrix} \\ {s}_{2}^{m} = \frac{{p}_{2 Ω} ( m ) - {p}_{Ω} ( m )}{Ω}\end{matrix} \qquad [ equation 35 ]$$

If the equations 26 to 35 are used, it is possible to obtain the available bandwidth ratio of the equation 21. At this time, in case of knowing the bandwidth of the node, the available bandwidth of the node can be obtained by multiplying the available bandwidth ratio by the bandwidth of the node.

As described above, even when the separate program or function is not activated in the router, it is possible to easily estimate and monitor the available bandwidth of the exterior network link connected to the network being managed.

Accordingly, it is possible to operate the network more stably and to detect the abnormal sign of the network at early stage, thereby quickly coping with it. In addition, it is possible to prevent the excessive traffic or load from being caused in the network.

While the invention has been shown and described with reference to certain preferred embodiments thereof, it will be understood by those skilled in the art that various changes in form and details may be made thereto without departing from the spirit and scope of the invention as defined by the appended claims.

What is claimed is:

1. A method for estimating an available bandwidth of a network link belonging to an exterior network, the method comprising steps of:
(a) transmitting a first packet (packet 1) to a node j which is a back node of the network link;
(b) transmitting a second packet (packet 2) and a third packet (packet 3) to a node i which is a front node of the network link; and
(c) calculating an available bandwidth of the network link from time information of time stamps recorded in the packets 1 to 3 transmitted.

2. The method according to claim 1, wherein the node i and the node j are adjacent to each other or are connected to each other by one or more other nodes.

3. The method according to claim 1, further comprising a step of examining whether the node i and the node j provide a time stamp function of an Internet control message protocol.

4. The method according to claim 1, further comprising a step of, when transmitting a plurality of packets to the node i, determining whether routes through which each of the packets is transmitted to the node i are same each other.

5. The method according to claim 1, wherein the packets 1 to 3 are transmitted back-to-back in the steps (b) and (c).

6. The method according to claim 1, wherein sizes of the packets 1 to 3 are set such that a relation of a following equation 3 is established between the sizes of the packets 1 to 3 and bandwidths of the nodes i and j:
$$\frac{{L}_{k}}{{L}_{k + 1}} ≻ {max}_{m \leq j - 1} \frac{2 {C}_{m}}{{C}_{m - 1}} \qquad [ equation 3 ]$$
where,
Lₖ: size of the packet k [byte],
max(.): maximum of a function (.), and
Cₘ: bandwidth of a node m [byte/sec].

7. The method according to claim 1, wherein sizes of the packets 1 to 3 are set such that the size of the packet 1 is 8 times or more as large as the size of the packet 2 or 3.

8. The method according to claim 1, wherein a size of the packet 1 is set to be an allowable maximum packet size and a size of the packet 2 or 3 is set to be an allowable minimum packet size.

9. The method according to claim 1, wherein the step (c) comprises steps of:
(c1) repeating the steps (a) and (b) several times;
(c2) calculating a probability (Pr(X=Ω)) that a difference (X=I′ᵢ(2,3)−I′ᵢ(1,2)) between I′ᵢ(2,3) which is a delay difference of the packets 3 and 2 and I′ᵢ(1,2) which is a delay difference of the packets 2 and 1 will be Ω from a following equation 23;
(c3) using the α_{Ω} calculated in the equation 23 and a measured delay value \hat{D}_{i,j}(1) to calculate a minimum n value satisfying an inequality of a following equation 25, thereby estimating a minimum delay value \hat{D}*_{i,j}; and
(c4) calculating a bandwidth ratio (a/c=1−ρ) with a following equation 21:
$$\begin{matrix}\begin{matrix}Pr ( X = Ω ) = ( the number of packets of which the \\ delay of packet 3 and the delay of \\ packet 2 are different ) / ( the total number \\ of packets sent ) \times ( the number of \\ packets of which the delay of \\ packet 3 and the delay of packet 2 \\ are same ) / ( the total number of packets \\ sent ) \\ = {a}_{Ω}\end{matrix} & [ equation 23 ] \\ {\hat{D}}_{\hat{i} , j} = Ω \times min \{ n \text{:} Pr ( {\hat{D}}_{i , j}^{′} ( 1 ) \leq n Ω ) ≻ {a}_{Ω} \} & [ equation 25 ]\end{matrix}$$
Pr(D_{i,j}(1)≦D^{m}_{i,j})=2Pr(\tilde{D}_{i,j}(1)≦D^{m}_{i,j}+Ω)−Pr(\tilde{D}_{i,j}(1)≦D^{m}_{i,j}+2Ω) [equation 21]
where,
Ω: the minimum time unit of delay provided from the time stamp,
α_{Ω}=Pr(X=Ω),
\hat{D}′_{i,j}(1): delay value measured from the time stamp recorded in each packet and expressed by a following equation 26,
\tilde{D}′_{i,j}(1)(=D_{i,j}(1)−X): delay of the packet 1 between the nodes i and j, which considers the error item X,
the variables of the right item in the equation 21 are calculated with following equations 26 to 35:
\tilde{D}′_{i,j}(1)=D′_{0,j}(1)+D′_{0,i}(3)−2D′_{0,i}(2) [equation 26]
where,
D′_{0,j}(1), D′_{0,j}(2) and D′_{0,j}(3) are obtained from the time stamps of the three probing packets;
the right term of the equation 21 in n^{th} (n=1, 2, 3, . . . ) observation interval is calculated with a following equation 28:
Pr(\tilde{D}′_{i,j}(1)≦D_{i,j}^{m}+Ω)≈(1−ξ(n))p₀(n)+ξ(n)p_{Ω}(n)
Pr(\tilde{D}′_{i,j}(1)≦D_{i,j}^{m}+2Ω)≈(1−ξ(n))p₀(n)+ξ(n)p_{2Ω}(n) [equation 28]
where,
p₀(n), p_{Ω}(n) and p_{2Ω}(n) are defined as values of p₀, p_{Ω} and p_{2Ω} observed in the n^{th} (n=1, 2, 3, . . . ) observation interval,
p₀, p_{Ω} and p_{2Ω} are defined as a following equation 27 and values thereof can be expected through a measurement:
p₀=Pr(\hat{D}′_{i,j}(1)≦D*_{i,j})
p_{Ω}=Pr(\hat{D}′_{i,j}(1)≦D*_{i,j}+Ω)
p_{2Ω}=Pr(\hat{D}′_{i,j}(1)≦D*_{i,j}+2Ω) [equation 27]
where,
D*_{i,j}: minimum delay between the nodes i and j, which can be obtained through a measurement,
ξ(n): a parameter representing a phase of the minimum delay, and ξ(1) is estimated as \hat{ξ}(1) of a following equation 29:
$${ξ}^{⋒} ( 1 ) = \frac{{x}^{′}}{Ω} \qquad [ equation 29 ]$$
where,
x′ is expressed by a following equation 30:
$${x}^{′} = - \frac{1}{{C}_{3}^{′}} log \frac{{C}_{1}^{′} - {a}_{Ω} {p}_{2 Ω}}{{C}_{2}^{′}} \qquad [ equation 30 ]$$
C₁′, C₂′ and C₃′ are expressed by a following equation 31:
$${C}_{1}^{′} = {p}_{0} + \frac{{( {p}_{0} - {p}_{Ω} )}^{2}}{( 2 {p}_{Ω} - {p}_{0} - {p}_{2 Ω} )} \\ {C}_{2}^{′} = \frac{{( {p}_{0} - {p}_{Ω} )}^{3}}{( {p}_{0} - {p}_{2 Ω} )} \cdot \frac{1}{( 2 {p}_{Ω} - {p}_{0} - {p}_{2 Ω} )} \\ {C}_{3}^{′} = log ( \frac{( {p}_{0} - {p}_{Ω} )}{( {p}_{Ω} - {p}_{2 Ω} )} \cdot \frac{1}{Ω} ) \qquad [ equation 31 ]$$
in case of n>1, a value of ξ(n) is estimated with a following equation 32:
$${ξ}^{⋒} ( n ) = \frac{{G}_{n - 1} ( Ω ) - {p}_{0} ( n )}{{G}_{n - 1} ( Ω ) - {{a}_{Ω} ( n )}_{2 Ω} ( n - 1 )} \qquad [ equation 32 ]$$
where,
α_{Ω}(n): value of an obtained in the n^{th} observation interval,
Gₘ(x): defined as a following equation 33 for an m^{th} exploration period,
Gₘ(Ω) value of Gₘ(x) when x=Ω, and
x″: delay value at an intersection point of two functions, f₁^{m}(x) and f₂^{m} (x):
$${G}_{m} ( x ) = \{ \begin{matrix}{f}_{1}^{m} ( x ) , if x ≺ {x}^{″} \\ {f}_{2}^{m} ( x ) , if x \geq {x}^{″}\end{matrix} \qquad [ equation 33 ]$$
where,
f₁^{m} (x), f₂^{m} (x) are respectively as a following equation 34:
f₁^{m}(x)=s₁^{m}(x−(1−ξ)Ω)+p₀(m)
f₂^{m}(x)=s₂^{m}(x−(2−ξ)Ω)+p_{Ω}(m) [equation 34]
s₁^{m}, s₂^{m} are respectively as a following equation 35:
$$\begin{matrix}{s}_{1}^{m} = \{ \begin{matrix}\frac{{p}_{0} ( m ) - {a}_{Ω} ( m ) {p}_{2 Ω} ( m )}{( 1 - ξ ) Ω} , & \begin{matrix}if \frac{{p}_{0} ( m ) - {a}_{Ω} ( m ) {p}_{2 Ω} ( m )}{( 1 - ξ ) Ω} > \\ \frac{{p}_{Ω} ( m ) - {p}_{0} ( m )}{Ω}\end{matrix} \\ \frac{{p}_{Ω} ( m ) - {p}_{0} ( m )}{Ω} , & otherwise\end{matrix} \\ {s}_{2}^{m} = \frac{{p}_{2 Ω} ( m ) - {p}_{Ω} ( m )}{Ω}\end{matrix} \qquad [ equation 35 ]$$

10. The method according to claim 9, further comprising a step (c5) of multiplying the bandwidth ratio by a bandwidth of a corresponding node to calculate an available bandwidth of the corresponding node.
